(19) United States
(12) Patent Application Publication
(10) Pub. No.: US 2007/0096685 A1
(43) Pub. Date: May 3, 2007

(54) Apparatus for charging handheld units

(75) Inventors: Klas Skogmar, Malmo (SE); Fabian Hagman, Malmo (SE); Andreas Alptun, MALMO (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: Q - DOG AB,, Malmo (SE)

(21) Appl. No.: 11/163,736

(22) Filed: Oct. 28, 2005

(51) Int. Cl. H02J 7/00

(52) U.S. Cl. 320/107

(57) ABSTRACT

A charger for handheld units is also an automatic backup unit for data stored in the handheld unit. The communication with the handheld unit is performed through a predefined object transfer protocol. By using an object transfer protocol, it is up to the handheld unit how to interact with the charger/backup unit when the communication has been initiated. Previous versions of the data may be stored and retrieved. It is possible to access the stored data and control the settings of the charger/backup unit from a handheld or a computer.

### FIELD OF THE INVENTION

The present invention relates to chargers for handheld units and the field of data processing and communication systems. Specifically, the present invention relates to a system for storing data obtained from a handheld unit for backup purposes while charging the handheld's batteries.

### RELATED ART

U.S. Pat. Nos. 6,664,760, 6,611,849

Extensive data can be stored in handheld units such as mobile phones PDA.s etc. This data must be backed up somewhere and be recoverable should it become lost or corrupted in the handheld memory, be inadvertently deleted or the handheld be lost.

Current backup solutions for handheld units are focused on the usage of a computer to synchronize the data with. This may not be appropriate in all situations for all people. Many people do not own a computer, do not synchronize, or do it rarely, even if they own one.

For mobile phones, the backup routines have changed dramatically since the stored data became too large to fit on the phone's SIM card. The phones must be backed up against a computer, which requires user interaction. New technologies are emerging like wireless backup to a server, but such data is not secure.

Conventional chargers do not do anything more than charging the batteries in the handheld unit. There are some other solutions emerging, though, that access the memory of the phone. These existing solutions read out data stored in the memory, meaning that they cannot access information that is accessible on higher level protocols, like current time or user specific information, for example the phone number and serial numbers. This type of information is needed to create functional versioning control and for using multiple handhelds with one charger. Also, there is no way for the connected handheld to decide what, if and how the data should be sent. By moving these decisions to the handheld, the manufacturer and the user can decide what level of security and flexibility that is required. The solutions also use buttons and indicators on the charger backup unit, which requires interaction.

In addition to the problems described above, the previously mentioned solutions do not have a way of restoring the phone to previous versions of the content. The problem of how to store data from the large memory of the phone to the much smaller memory of the charger backup unit should be handled. This is a vital part of charger backup units for mobile phones. Also, a charger backup unit should be able to secure the data so that others cannot obtain sensitive data without permission.

### SUMMARY OF THE INVENTION

The invention simplifies the backup of data in handheld units by performing a backup while charging the batteries of the handheld unit. A handheld unit can be a phone, a camera, a PDA, a notebook, etc. The invented apparatus consists of one part, the charging unit—responsible for charging a handheld unit, and one part, the charger backup unit—which requests data from the handheld unit and stores the obtained data on a memory. The proposed solution uses an object transfer protocol for transferring the data to the charger backup unit. It is up to the handheld unit to accept or deny the apparatus to access all, or parts, of the data. This means that handhelds can be constructed so that only certain apparatuses are allowed to retrieve the data, or that only certain parts of the data should be backed up or restored.

An object transfer protocol is used to transfer objects between the charger backup unit and the handheld unit. These protocols are often packet based, meaning that small, well defined data packages are sent between the devices. An object may be any kind of data package, for example an image, a contact list or an organizer file. The handheld unit acts as a server and the charger backup unit acts as a client when communicating. The client issues a “get” packet to fetch an object from the server. The server responds with a packet containing the requested object. The object data may be split up into many packets and sent sequentially since the maximum packet size has often been negotiated by the devices. The client can send objects to the server by issuing a “put” packet followed by the object data split up into a number of packets.

Using an object transfer protocol enables access to other information in the handheld unit like time-stamps and unit identifier. It has the added benefit that only data that has changed since last backup need be transferred. The data can be contact data, calendar data, messages, notes, images and music.

Using an object transfer protocol gives the possibility to write programs for user interaction on the handheld. Putting the user interaction on the handheld opens up new possibilities like being able to choose previous versions of backups by selecting the time it was backed up or by a version number. Backup is automatic and requires no user interaction. User interaction is only needed when a restore is performed.

Optionally, the apparatus in accordance with the invention could include a slot for external memory in addition to the one included on the charger backup unit. An external memory would increase the capacity so that more data can fit. Often, a memory card with limited capacity is bundled with handheld units when purchased. These cards are often replaced with cards of higher capacity, and the former card is no longer used. Instead the bundled card can be reused by inserting it into the charger backup unit.

The invented apparatus can prioritize the data requested, and thus store the most important data, discarding what cannot fit in the memory. The invention has the optional possibility of using a removable memory for the backup, which makes it possible to increase the storage space and thus being able to store more of the data obtained from the handheld unit. For security purposes, the invention may encrypt the obtained data.

Another feature of the invented apparatus is the possibility of adding handling of different versions of the backup data. Some of the data may not be overwritten each time a backup is performed, thus enabling the user to restore data from previous backups. When the data is stored it is possible to store information about the time, version or an identification key, which then can be used to restore a specific version of the backed up data.

There are several ways to identify a handheld unit and its user. By using identifiers, different handheld units can be prevented to interfere with each other. Data from different id's can be stored on different memory areas or other identifiers can be denied to use the charger backup unit.

A user interface on the handheld unit can add additional features, like the ability to select what data that should be backed up, and the priorities of this data, and even synchronization between more than one handheld unit, removing the need for a computer to achieve the same thing.

The invention could also include a small serial port or a chip for wireless communication, to make it possible to transfer the stored data to a computer or other units. This gives the user more options when having to restore the data. A port like this also makes it possible to set the preferences on the charger backup unit from a computer, for example what type of data that should be prioritized when performing a backup.

### DETAILED DESCRIPTION OF THE INVENTION

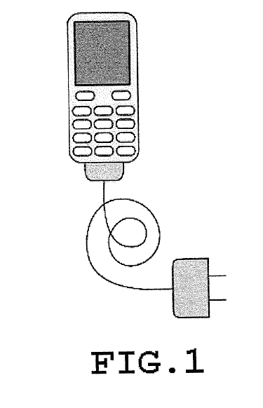

FIG. 1. shows a preferred embodiment of an apparatus in accordance with the invention and illustrates how the apparatus can be built, with the charger backup unit on one end of the cable together with the connector for the handheld and on the other end of the cable is the charging control unit, that is responsible for converting, directing and regulating the external voltage levels. When the charging unit is connected to a power source, it also powers the charger backup unit, which then polls for a connection to a handheld unit. When a handheld unit is connected, a connection is initiated by the charger backup unit. After the connection has been verified, it starts to communicate with the connected handheld unit by using the object transfer protocol, requesting data, allowing the handheld to accept or deny access to its data. This way it is possible for the handheld to limit the backups to only some of the data.

The charger backup unit can as an alternative be placed together with the charging control unit, and only keeping the connector for the handheld on the other end of the cable. A third option is to place some of the charger backup unit's circuits at either end of the cable. For example, there could be a slot for inserting an external memory on the charging unit, while the control circuit is located at the other end of the cable together with the connector for the handheld.

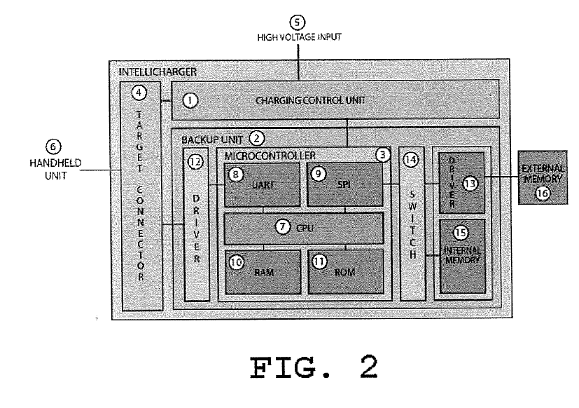

FIG. 2. is a schematic overview of the invention. A charging control unit (1) is connected to a normal high voltage power supply (5). The charging control unit converts the high voltage input to a low voltage power suitable for charging the batteries in a handheld unit (6) and also for powering a charger backup unit (2).

A connector (4) is connected to the handheld unit and allows the charging control unit (1) to provide a suitable voltage for charging the batteries in the handheld and allows the charger backup unit (2) to send and receive data.

The charger backup unit (2) consists of a microcontroller (3), drivers (12), a switch (14) and an internal memory circuit (15).

Drivers (12) are used for converting between digital voltages to be able to connect the microcontroller (3) to the handheld unit (6) and also to connect the microcontroller (3) to an external memory (16) via the switch (14).

The internal memory (15) is an embedded memory circuit that contains non-volatile memory cells. These memory cells do not require continuous power for storing data.

The external memory (16) can be a memory card or some other memory circuit. This memory should be of a non-volatile type.

The microcontroller (3) is used for controlling the data flow between the handheld unit and the memory circuits. The predefined object transfer protocol is implemented in the microcontroller. It contains a central processing unit (7) and features like a non-volatile program memory (11), a volatile data memory (10), a universal asynchronous serial receiver and transmitter (8) for communicating with the handheld unit, a serial peripheral interface (9) for accessing the data in the internal and the external memory in a synchronous manner.

The volatile RAM memory (10) is used for holding input/output buffers, program variables and the program stack. The non-volatile ROM memory (11) is used for storing the program to be executed in the CPU (7) and for storing constant data.

The program run by the CPU regularly polls for a connected handheld unit (6), connected to the connector (4). When a handheld is connected and responds to the connection request sent by the charger backup unit, initial setup is performed and then the communication is started using the object transfer protocol.

The communication could be asynchronous (as shown in FIG. 2), or synchronous depending on the data communication interface in the handheld unit. First, the identity of the handheld unit is determined, which is obtained through the object transfer protocol. If the apparatus is set in a single-user mode, then only that identity can store data on the apparatus. It is still possible to restore a handheld unit with a different identity, so that, for example, a replacement unit can obtain the backed up data. Before storing the data, the data may be encrypted to ensure that only the user with a correct password can access the data.

The charger backup unit can request data that should be backed up by using the previously mentioned object transfer protocol. The handheld can then send the data it chooses to the charger backup unit for storage. The charger backup unit has a predefined priority list of all types of data that can be backed up. The data with the highest priority is likely to be the contact list and calendar data. The charger backup unit stores the data on its memory (15 or 16) according to this priority list, so that when the memory is full, the data with the highest priority is kept, while the least prioritized data is discarded. A switch (14) is used to define which memory the data should be stored in—the internal memory (15) or an external memory (16). Initially the most vital data is stored on the internal memory according to the previously mentioned priority list. When the internal memory is full, all data that can fit on the external memory, if one exists, is stored.

When data is acquired, older versions of the data already stored on the charger backup unit may be kept, especially important data that does not require a lot of space. These previous versions of the data can be retrieved from a more advanced interface, for example a program on the handheld.

It is possible to change the state to a restore mode on the apparatus from the handheld unit. This could for example be a program that is installed on the handheld unit. A program like this could enable more features, like browsing through previous backups, or backups from other handhelds. The handheld then uses the same communication channel as when an automatic backup is performed. Through the handheld, it is possible to change the settings on the apparatus as well, for example the priorities of the data when performing a backup.

By using a separate serial port, it is possible to transfer the data stored in the apparatus to some other unit, like a computer or another handheld. This port may have a different interface than the connector of the apparatus. It could also be a radio chip for communicating with units wirelessly. These extra ways of communicating can be used to change settings on the apparatus or to get the backed up data from it.

What is claimed is:

1. An apparatus to be connected to a handheld unit to charge one or more batteries of the handheld unit, comprising:
a charging control unit for converting an external voltage into a charging voltage and supplying the charging voltage to the handheld unit; and
a backup unit implementing an object transfer protocol supported by the handheld unit used for communicating with said handheld unit,
wherein data may be exchanged between the handheld unit and said apparatus through said protocol, where parts, or all, of said data is stored in said apparatus.

2. Apparatus as claimed in claim 1, wherein said stored data is stored in different memory areas in one or more physical memories based on unique identification keys.

3. Apparatus as claimed in claim 2, further comprising a removable memory card wherein parts, or all, of said data is stored.

4. Apparatus as claimed in claim 1, wherein the data in said charger backup unit is retrieved by changing the state of the charger backup unit before or after a handheld unit is connected to said charger backup unit.

5. Apparatus as claimed in claim 1, wherein some of said stored data is not overwritten each time new data is stored, so that previous versions of said data can be retrieved from said charger backup unit.

6. Apparatus as claimed in claim 5, wherein said charger backup unit stores particulars about the time, version or an identification key together with said stored data.

7. Apparatus as claimed in claim 1, wherein said stored data stored in said charger backup unit can be retrieved through a predefined object transfer protocol.

8. Apparatus as claimed in claim 7, wherein a user interface on the handheld unit is used to retrieve said data.

9. Apparatus as claimed in claim 1, wherein the data is set to be prioritized to for example exclude data that cannot fit in the memory of the charger backup unit.

10. Apparatus as claimed in claim 9, wherein said prioritization settings can be set by a user.

11. Apparatus as claimed in claim 1, wherein a connector, or a separate serial port, enables communication with other units than the handheld unit.

12. Apparatus as claimed in claim 1, wherein a radio chip enables wireless communication with the handheld and other units.

13. Apparatus as claimed in claim 1, wherein the data is encrypted before being stored.
